(19) United States
(12) Patent Application Publication
(10) Pub. No.: US 2004/0024690 A1
(43) Pub. Date: Feb. 5, 2004

(54) Volume limitation method and system for a real-time computerized stock trading system

(75) Inventors: Michael Satow, New York, NY (US); Eugene Choe, Cliffside Park, NJ (US); Michael Hermus, New York, NY (US); Stanley Leong, Bayside, NY (US)

Correspondence Address: Kamran Khan, 31st Floor, 135th East 57th Street, New York, NY, 10022, US

(73) Assignee: MarketXT, Inc.

(21) Appl. No.: 10/633,513

(22) Filed: Aug. 5, 2003

Related U.S. Application Data
(63) Continuation of application No. 09/376,377, filed on Aug. 18, 1999, now abandoned.
(60) Provisional application No. 60/097,414, filed on Aug. 21, 1998.

(51) Int. Cl. G06F 17/60

(52) U.S. Cl. 705/37

(57) ABSTRACT

A system controls the volume of trading for an individual investor for a given stock and protect against market domination in real-time computerized stock trading systems. These stock trading systems may provide trading environments that do not have sufficient liquidity and may thus be susceptible to market domination due to large trade orders placed typically by large institutions or users with great resources. The system determines a volume limit and rejects or flags new trade orders that make a user's total trading volume for a certain stock exceed the determined volume limit.

### RELATED APPLICATIONS

This patent application claims priority to Provisional U.S. Patent Application No. 60/097,414, entitled “Online Trading System” and filed on Aug. 21, 1998, which is herein incorporated by reference.

The following identified U.S. patent applications are relied upon and are incorporated in their entirety by reference in this application.

U.S. patent application Ser. No. ______, entitled “A Real-Time Computerized Stock Trading System” bearing attorney docket no. 07444.0001, and filed on the same date herewith.

U.S. patent application Ser. No. ______, entitled “Anti-Manipulation Method and System for A Real-Time Computerized Stock Trading System” bearing attorney docket no. 07444.0012, and filed on the same date herewith.

### BACKGROUND

The present invention relates generally to stock trading, and more particularly to a method and system for limiting the volume of trading on a real-time computerized stock trading system.

Many stock trading environments with many investors have a high degree of “liquidity,” which is a level of trading volume that makes it easy to buy or sell a particular security, making that security “liquid.” In simple terms, there are a lot of buyers, sellers, and trades. The most important thing that liquidity provides is price efficiency: the more liquidity, the more efficient the market, and the closer the price will be closer to the “true” price (in a perfectly efficient market). This makes it very difficult for one person or organization to affect the market or the price of the security. Some trading environments are illiquid and thus susceptible to domination by larger institutions. A trading environment may be illiquid if it does not have enough investors trading on it, thus causing situations where there are not enough buyers for the sellers, or vice versa. In this case, large individual trade orders could easily “absorb” the market's liquidity, thus making it difficult for other orders to be executed. Such illiquid trading environments may be dominated by investors with great resources because smaller investors on the system may have to wait for larger trade orders to fill before they may trade at different prices.

Large trading volume by an investor with larger resources may cause other smaller investors to change their trading prices which in turn affects the market. Suppose there is an investor with large resources trading on an illiquid computerized trading system in which buying and selling trade orders are posted on the system. If the trading system accepts, for example, a sell order for a million shares of a certain type of stock at 100 dollars per share, any investor who wants to sell shares of the same stock at or below 100 dollars may have to wait for the large trade order to fill up. Similarly, if the order is a buy order, other investors who wish to buy the stock may have to place their orders at or above 100 dollars to get shares of the stock. The large trade order may force sellers to sell their shares for a lower price until the large trade order fills up, and buyers to buy at a higher price for the same period of time. Additionally, a large trade order may adversely affect the market by buying all available shares of a certain stock so that no one else may purchase that stock. This type of large order, such as those that large institutions are able to place, may affect illiquid markets by influencing prices, absorbing liquidity and dominating the smaller trading environment.

### SUMMARY

In accordance with the present invention, an automated method for controlling trading volume in a data processing system for trading stocks in real-time receives a trade order indicating a number of shares to be traded and determines a limit for a number of shares to be traded. It further rejects the trade order based on whether the number of shares to be traded is equal to or greater than the determined limit.

In accordance with another aspect of the present invention, a trading volume limitation system for a real-time computerized stock trading system comprises a receiving component configured to receive a trade order outside of exchange trading hours from a non-institutional user, and a matching engine configured to match trade orders and execute trades in real-time between matching trade orders. It further comprises a volume limiting component configured to receive a trade order indicating a number of shares to be traded, determine a limit for a number of shares to be traded, and reject the trade order based on whether the number of shares to be traded is equal to or greater than the determined limit.

### BRIEF DESCRIPTION OF THE DRAWINGS

The accompanying drawings, which are incorporated in and constitute a part of this specification, illustrate an implementation of the invention and, together with the description, serve to explain the advantages and principles of the invention. In the drawings,

FIG. 1 illustrates a block diagram of a real-time computerized trading system with an anti-manipulation component in accordance with the present invention;

FIG. 2 displays a flowchart illustrating the steps of a method for placing a trade order in the trading system in accordance with the present invention;

FIGS. 3A, 3B and 3C depict exemplary broker-dealer order entry screens in accordance with the present invention;

FIG. 4 illustrates the steps of a method for matching a trade order in the trading system in accordance with the present invention;

FIG. 5 depicts the steps of a method for publishing the trading system market information over a network such as the Internet in accordance with the present invention;

FIG. 6 shows a market information mechanism in accordance with the present invention; and

FIG. 7 depicts the steps of a method for limiting trading volume in a trading system in accordance with the present invention.

### DETAILED DESCRIPTION

Methods and systems consistent with the present invention limit the volume of trading and protect against market domination in real-time computerized stock trading systems. These stock trading systems may provide trading environments that do not have liquidity and may thus be susceptible to market domination and hindrance of trading due to large trade orders placed typically by large institutions or users with great resources. For instance, if a user places a large trade order for certain type of stock, other users may have to wait for that trade order to be filled before they may sell above the price of that trade order or buy below the price of the trade order. Large trade orders such as this may limit liquidity in a real-time computerized trading system. Methods and systems are provided to reject such trade orders.

One system in accordance with the present invention initially determines a volume limit. For each trade order entering the system, if the amount of shares attempted to be traded in the trade plus the amount of pending open trade orders for that user for the same stock is greater than the determined volume limit, the trade order is rejected or flagged. Another system in accordance with the present invention rejects only the portion of the trade order having the stock with the amount of shares over the determined volume limit.

Methods and systems in accordance with the present invention may be used in computerized trading systems that service both retail and institutional investors, connect investors at different brokerage firms, and operate during and after financial market hours. It should be noted that after-hours refers to any time outside of exchange trading hours, i.e., any time the primary securities exchanges such as the New York Stock Exchange and the American Stock Exchange do not accept for immediate execution purchase or sale orders for securities, including before the exchanges open. Such systems may have aspects of illiquidity or may be susceptible to the previously mentioned problems due to the inclusion of both retail and institutional investors. Furthermore, the volume problem may arise in such systems because they may require open orders at the best price to be executed before others can be executed. Consequently, protection mechanisms in accordance with the present invention may be particularly useful for such computerized trading systems because they may have aspects of illiquidity due partly to the mix of retail and institutional investors.

To describe methods and systems in accordance with the present invention, first, an example of a real-time computerized trading system is described. Methods and systems in accordance with present invention may be used with such a trading system, and this trading system is similarly described in co-pending U.S. patent application Serial No. ______. The description of the system is followed by description of volume limitation and systems in accordance with the present invention.

Trading System

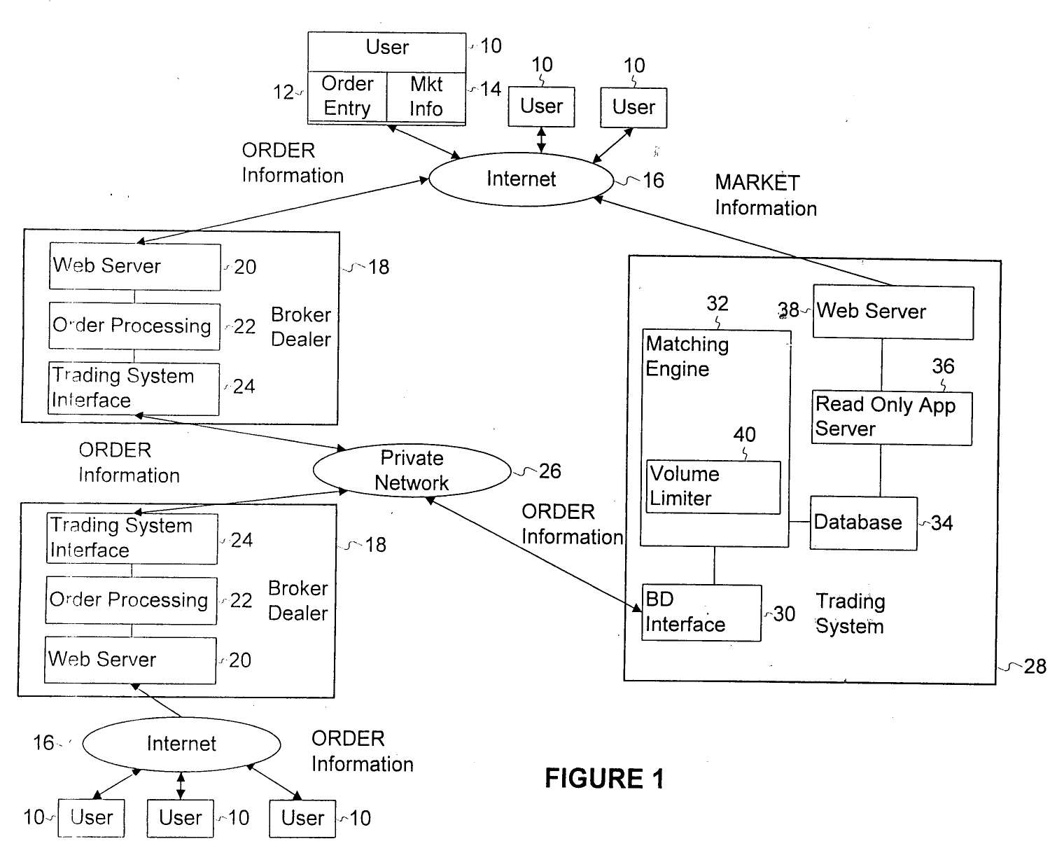

FIG. 1 illustrates a block diagram of an exemplary real-time computerized trading system consistent with the present invention. Retail or institutional investors, referred to as users 10, may access the trading system 28 directly through their personal computers using the existing online trading networks of their brokerage firms, referred to as broker-dealers 18 (“BD”). The trading system 28 contains the volume limiter 40 which may be implemented as software or hardware and is described below. Online investors' trades may be filtered through their broker-dealers' computer systems, as they currently are, to ensure that the investors' accounts contain necessary buying power and meet requirements imposed by the broker dealers 18 for the transactions they wish to conduct on the system. However, the user 10 does not necessarily have to connect to the system through a brokerage firm, and the connection may be directly to the trading system 28 or by other means. Additionally, users 10 may also be broker-dealers 18.

The computer systems used by users 10, broker-dealers 18, and the trading system 28 may be general-purpose computers that run the necessary software and contain the necessary hardware components for implementing methods consistent with the present invention. These computer systems may also have additional components not shown on FIG. 1. Furthermore, although two broker-dealers 18 and six users 10 are shown on the figure, any number of broker-dealers 18 and users 10 may use the trading system 28 in accordance with the present invention.

The various software components of a system consistent with the present invention may be programmed in a programming language such as the Java™ programming language, which is further described in “The Java Programming Language,” 2^{nd} Ed., Ken Arnold, James Gosling, Addison-Wesley, 1998, which is incorporated herein by reference. For further description of the Java language, refer to, “The Java Language Specification,” James Gosling, Bill Joy, Guy Steele, Addison-Wesley, 1996 which is also incorporated herein by reference. When programmed in the Java programming language, the source code for the software is portable across multiple operating systems (i.e., Unix, NT, etc.) and easily deployed over the Internet, but other programming languages may also be used.

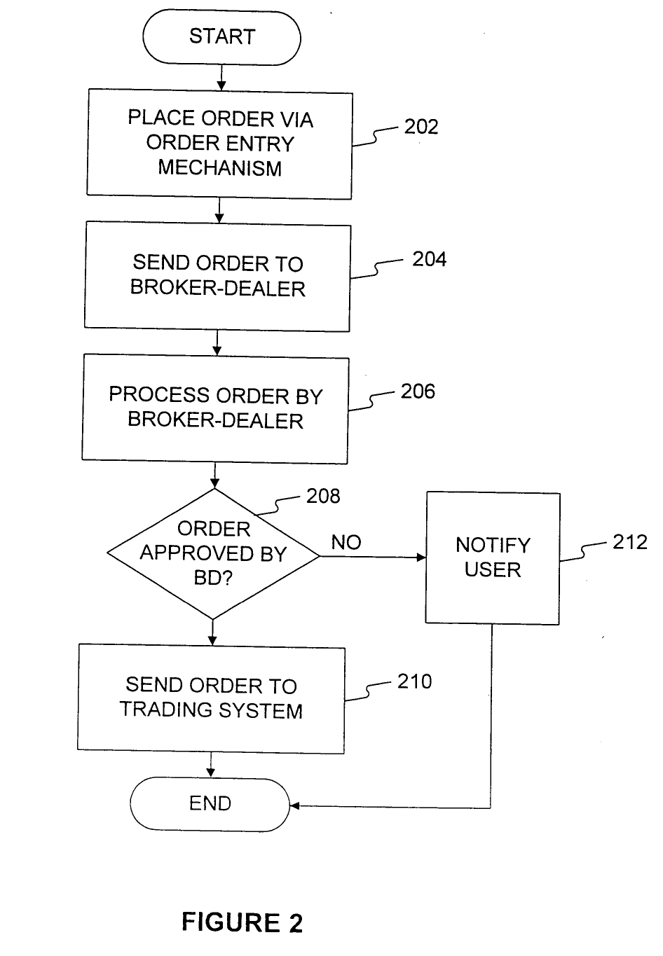

FIG. 2 illustrates a flowchart of the steps of a method for placing a trade order in the trading system in accordance with the present invention. Generally, a user 10 enters a trade order through the order entry mechanism 12 that is, in one implementation, supplied by the broker-dealer 18 (step 202). The order entry mechanism 12 may be an applet containing screens used to interface with the broker-dealer 18. The user 10 may make decisions on various trades based on information from the market information mechanism 14, which will be described below.

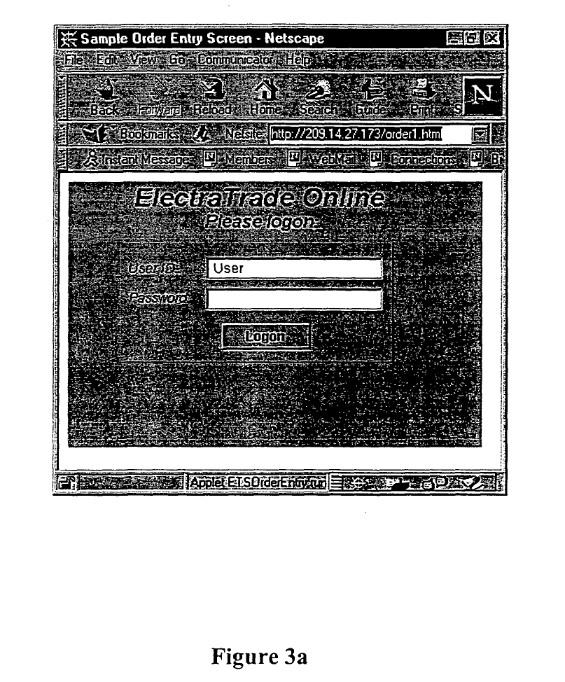

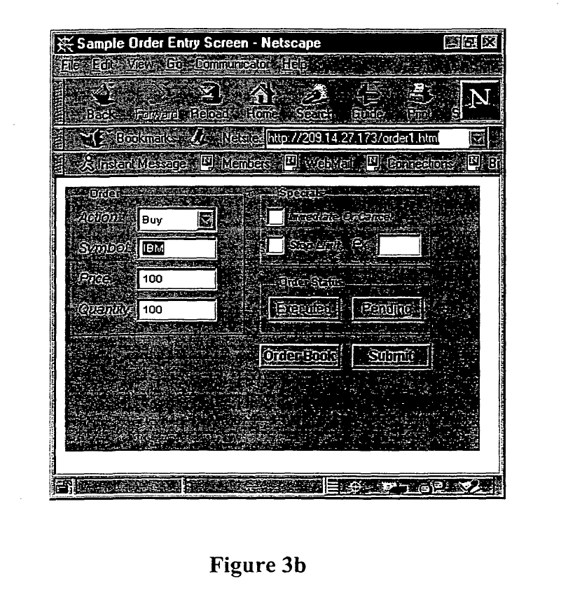

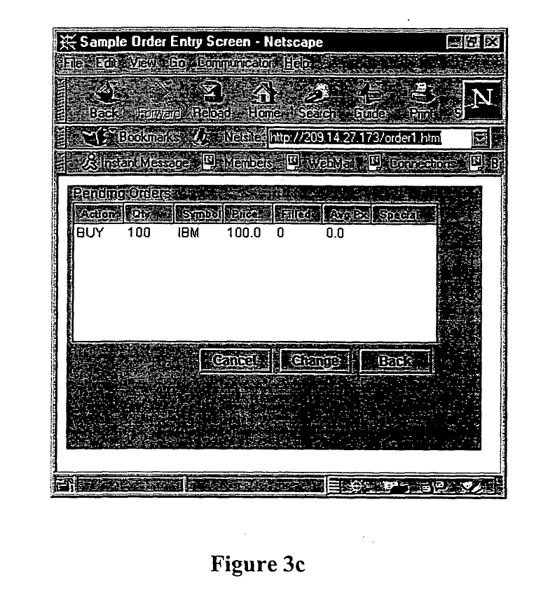

FIG. 3A illustrates an exemplary broker-dealer's initial order entry screen in the order entry mechanism 12. Shown on the screen is a user identification and a password log on. The screens supplied to the user 10 in the order entry mechanism 12 may be the standard screens currently given to the user by a broker-dealer 18 with online capabilities, and they may vary greatly from the ones shown in the drawings.

FIG. 3B shows the next exemplary screen contained in the order entry mechanism 12 given to the user 110. On this screen, the user 110 may decide whether to buy or sell an amount of a certain type of stock at a specific price. For example, the screen in FIG. 3B shows a user 10 placing an order to buy 100 shares of IBM stock at one hundred dollars per share.

FIG. 3C depicts the following exemplary screen contained in the order entry mechanism, 12. This screen displays pending open orders for the exemplary user 110. As shown on the figure, the screen shows a user 10 placing an exemplary buy order for 100 shares of IBM stock at 100 shares, and it shows that the buy order has not yet been filled.

Referring back to FIG. 1 and FIG. 2, information entered by the user 110 to the order entry mechanism 12 travels to the broker-dealer 18 via a network 16 such as the Internet (step 204). This network 16 facilitates the transferring, of order entry information to and from the user 10 by the broker-dealer 18. As discussed below, it also facilitates the publication of the real-time market information to the user 10 from the trading system 28. In one system consistent with the present invention, when the user 10 communicates across the network 16 with the broker-dealer 18, it does so via the broker-dealer web server 20. The broker-dealer web server 20 is the broker web site which, in one implementation, hosts the order entry mechanism 12, which user 110 utilizes to enter trade orders. Once a trade order is entered, it is then relayed from the broker-dealer web server 20 to order processing, 22 on the broker-dealer 18.

Order processing 22 is a “black box” representation of a broker dealer's back-end system that performs order verification, updates account positions (i.e., cash and securities), updates buying power, etc. Before the trade order is routed for execution (to the principal market exchanges or to the trading system 28 described below), order processing 22 verifies the order to make sure the account has the cash, securities or buying power to make the transaction (step 206). If approved (step 208), order processing 22 routes the trade order to the trading system interface 24, 11 which is a software component that forwards the order information to the trading system 28 across a private network 26 (step 210). If the trade order is not approved by the BD 18, the BD notifies the user 10 (step 212).

In one implementation consistent with the present invention, the private network 26 is a private leased line network for security and performance advantages. Private leased lines are essentially telephone lines that are leased from a phone company for exclusive use. They are secure because only one system uses the lines, and they offer better performance because the system does not share bandwidth with other systems or businesses. Although the private network 26 realizes some advantages, a public network may also be used.

The trading system interface 24 represents the order approving mechanism by which orders are translated and transmitted from the broker-dealer 18 to the trading system's broker-dealer interface 30. The trading system interface 24 receives order confirmation and execution information from the broker-dealer interface 30 after the order has been processed by the trading system 28. After execution on the trading system 28 (described below), the order execution information is relayed back to the trading system interface 24 and then to order processing 22. The order execution information received from the trading system 28 is used to update the account position and buying power in the account by the broker-dealer 18.

When a broker-dealer 18 routes orders and communicates with the trading system 28, it preferably communicates using the Financial Information Exchange protocol (“FIX”), a protocol developed by the securities industry to standardize communications between brokerage firms. Alternatively, the broker-dealers 18 and the trading system 28 may use other communication protocols.

The configuration and implementation of order processing 22 may vary widely among broker-dealers 18. Most notably, numerous broker-dealer 18 firms outsource order processing 22 to third party broker-dealers called “clearing firms” which perform order processing 22 and other back-office functions for multiple client broker-dealers firms. In this case, as indicated in FIG. 1, the link between the trading system 28 and the broker-dealer 18 (which, as shown on FIG. 1, is comprised of the trading system interface 24, private network 26, and BD Interface 30) is through the clearing firm.

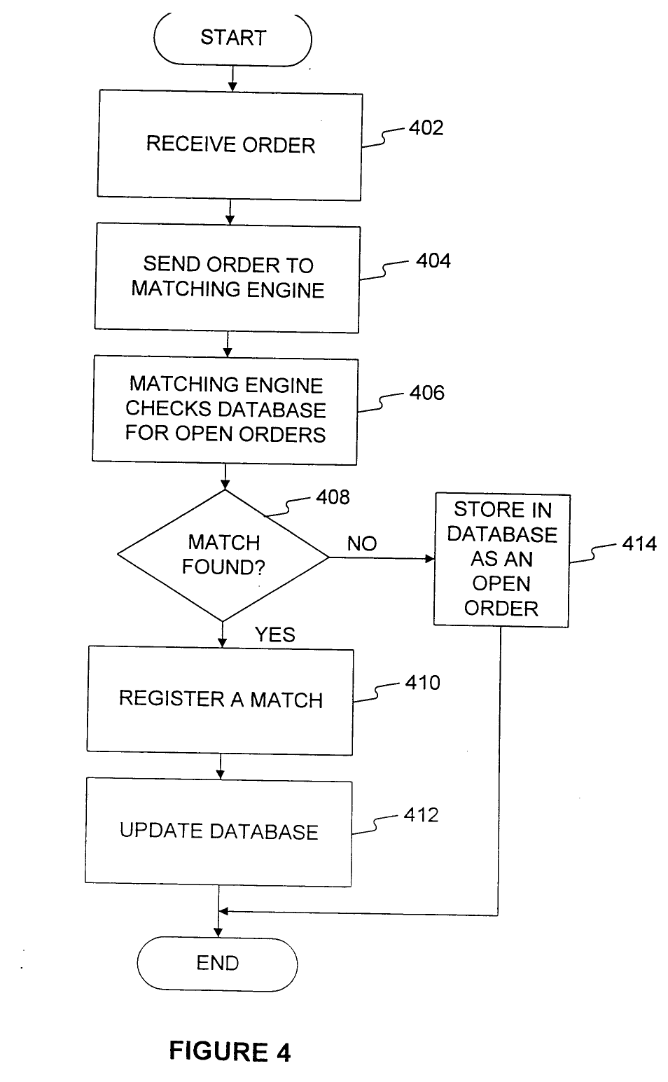

FIG. 4 illustrates the steps of a method for matching a trade order in the trading system in accordance with the present invention. The BD interface 30 on the trading system 28 is the component which receives orders from the BD 18 and sends confirmation/execution information back to the BD (step 402). It translates communications to the trading system 28 application programming interface (API), a formal set of specifications for one program to communicate with another program, which it uses to communicate with the matching engine 32 (step 404).

The matching engine 32 is the software component of the trading system 28 which actually performs order matches and executions. In one implementation consistent with the present invention, all of the matching logic (including anti-manipulation and other defensive schemes) is contained in the matching engine 32. In this implementation, the volume limiter 40 (described below) is shown in the matching engine 32, although other implementations may locate it. When the matching engine 32 receives trade orders, it checks the database 34 for open orders to be matched (step 406), determines if a match is made (step 408) and updates the database 34 accordingly. For example, if one user 10 has placed an order to sell a certain number of shares of a specific stock, and another user 10 has placed an order to buy a certain number of shares of the same stock, and their prices match, the matching logic in the matching engine 32 registers a match (step 410). The matching engine 32 determines how many shares of that stock will change possession from the seller to the buyer.

Generally, orders that cross the market will result in execution at the best counterpart price currently offered on the trading system 28. If a user does not wish to buy as many shares as a seller is offering, partial order matches may be executed and the remaining quantity of the larger order may remain open and post back to the trading system 28 to be matched. If a match is determined between two trade orders, the matching engine 32 executes the order immediately and relays the order execution information to the database 34 for persistent storage (step 412). If the matching engine 32 does not find a matching open order for the received trade order, the trade order is stored in the database 34 as an open order to be matched with future trade orders (step 414).

The database 34 is the central repository for information in the trading system 28, including open orders, execution information, and audit trails. In one implementation consistent with the present invention, the database server 34 is an object-oriented database, although a other types of databases may also be used. The database 34 on the trading system 28 stores the order information used by the matching engine 32 to determine a match. In doing so, it stores data relating to open orders and executed orders, in addition to other relevant data for the trading system 28.

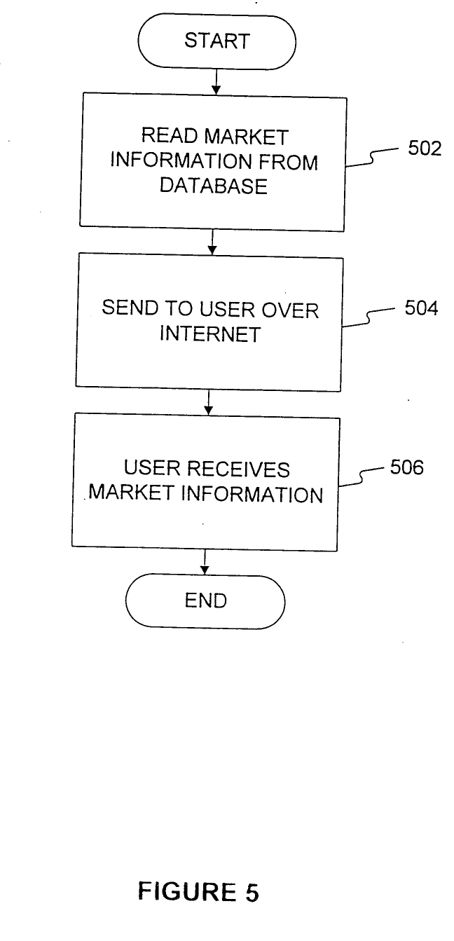

FIG. 5 depicts the steps of the method for publishing the trading system market information over a network, such as the Internet, in accordance with the present invention. While receiving and executing trade orders, the trading system 28 may also publish its market information in real-time over a network such as the Internet 16. The Read-Only Applet Server 36 on the trading system 28 reads market information to be displayed over the Internet 16. It receives the market information from the database 34 (step 502) and relays it to the user 10 via the trading system web server 38, which is the trading system web site that sends the market information over the Internet 16 (step 504). The trading system web server 38 hosts the market information mechanism 14, utilizing data from the Read-Only Applet Server 36. This market information mechanism 14 may contain an applet, referred to as an “order book,” showing open orders in the trading system 28 to the user 10 (step 506).

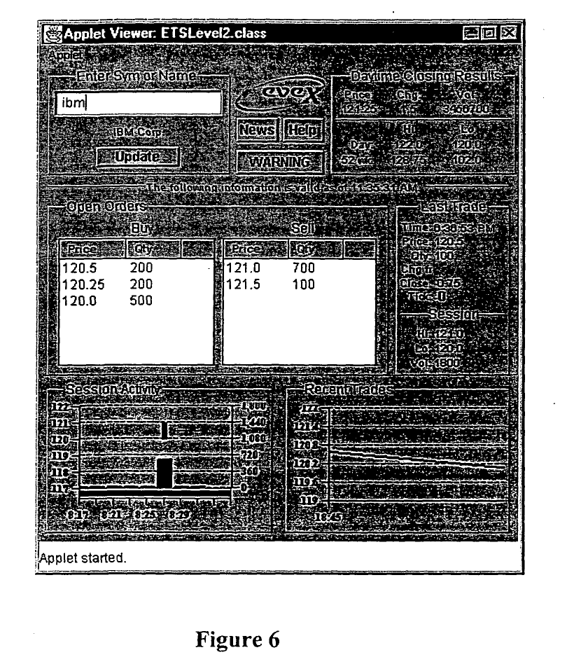

FIG. 6 illustrates an exemplary order book in accordance with the present invention. The order book provides real-time quotations of all open trade orders on the trading system 28, grouped by security and listed by price and time of entry, for example. Besides enabling users 10 of the trading system 28 to identify and follow their own orders on the trading system, the order book may also display additional information such as a stock's closing price for the day on the principal market including price, volume, high and low prices, and the price change for the day. It may also display the last price at which a stock was executed on the trading system 28 and the quantity and time of the trade. Additionally, the order book may give other information such as the price change from the closing price for the day on the principal markets, the chart of prices and times of all executions in that stock during the session, and session high, low and volume information for the stock.

Some implementations consistent with the present invention may further display additional information to keep the users 10 informed. This information may include a list of the most active stocks during a particular session, indications of price swings of more than a particular percentage (e.g., 10 percent), from the stocks closing price during a session. Furthermore, the order book may publish information regarding the types of orders that can be entered, in addition to real-time, after-hours news for use by all participating users 10 on the trading system 28 and the general public.

Volume Limitation

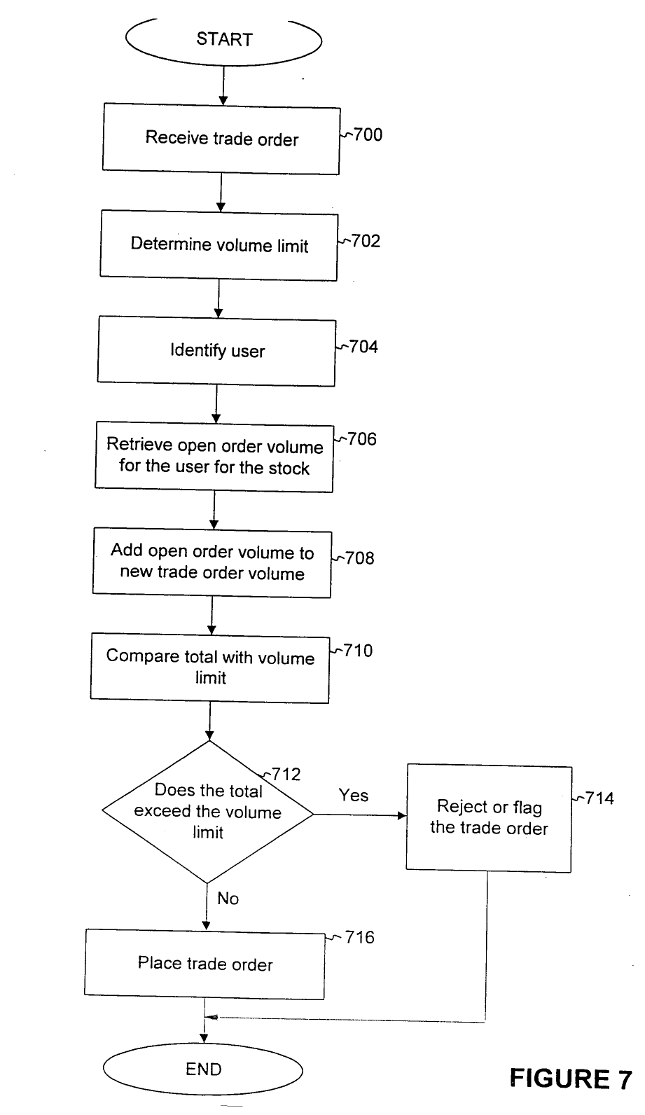

FIG. 7 illustrates the steps used in a method for limiting trading volume in a trading system in accordance with the present invention. In one implementation in accordance with the present invention, the volume limiter 40 uses or sets a trading volume limit, identifies trades having volume larger than the determined trading limit, rejects or flags these trades, and performs related functions. Generally, when a trade is flagged, the problem with the trade is pointed out to a system administrator and/or the user.

Initially, when the trading system 28 receives a trade order (step 700), the volume limiter 40 contains information on the volume limit to be used for the trading system 28. A programmer or trading system administrator may determine the volume limit, or it may be determined by the volume limiter 40 using programmed methods (step 702). In one implementation consistent with the present invention, a programmer or trading system administrator determines different volume level limits for different prices of stocks, and these volume level limits are stored in the trading system 28 to be used by the volume limiter 40. For example, a programmer or trading system administrator may set volume limits at 5000 shares if the stock's price is under 25 dollars, 4000 shares for stock prices between 25 and 50 dollars, 3000 shares for prices over 50 dollars, etc. In this case, the volume limiter 40 determines the volume limit based on the received trade order.

The volume limiter 40 uses the volume limit to determine whether a trade is valid. The volume limiter 40 identifies the user 10 that placed the trade (step 704), and retrieves the current volume information for that user for that particular stock (706). If the received trade is a buy order, the volume limiter 40 determines the volume of open buy orders for that stock for that user 10. If the received trade is a sell order, the volume limiter 40 determines the volume of open sell orders for that stock for that user 10. It then adds the volume of the new trade order to the existing open order volume for that stock for the user 10 to determine what the new total volume would be if the trade order was entered (step 708). The volume limiter 40 compares this total with the determined volume limit (step 710). If the volume limiter 40 determines that the new trade order makes the user's total buy or sell order volume for that stock exceed the volume limit (step 712), the volume limiter rejects or flags trade order (step 714). If the new trade order does not exceed the volume limit, the trading system 28 may continue to place the trade order as an open order (step 716).

The foregoing description of an implementation of the present invention has been presented for purposes of illustration and description. It is not exhaustive and does not limit the present invention to the precise form disclosed. Modifications and variations are possible in light of the above teaching or may be acquired from practicing of the present invention. The scope of the present invention is defined by the claims and their equivalents.

What is claimed is:

1. An automated method for controlling trading volume in a data processing system for trading stocks, the method comprising:
receiving a trade order outside of exchange trading hours from a non-institutional user indicating a number of shares to be traded in real-time;
determining a limit for a number of shares to be traded; and
rejecting the trade order based on whether the number of shares to be traded is equal to or greater than the determined limit.

2. The method of claim 1, further including the step of:
accepting the trade order if the amount of shares is less than the determined limit.

3. The method of claim 1, wherein the receiving step includes the step of:
receiving the trade order outside of exchange trading hours from a non-institutional user via a broker-dealer.

4. An automated method for controlling trading volume in a data processing system for trading stocks, the method comprising:
receiving a trade order outside of exchange trading hours from a non-institutional user indicating a number of shares to be traded in real-time;
determining a limit for a number of shares to be traded; and
flagging the trade order based on whether the number of shares to be traded is equal to or greater than the determined limit.

5. An automated method for controlling trading volume in a data processing system for trading stocks, the method comprising;
receiving a trade order indicating a number of shares to be traded;
determining a limit for a number of shares to be traded; and
rejecting the trade order based on whether the number of shares to be traded is equal to or greater than the determined limit.

6. A computer-readable medium containing instructions for controlling a data processing system to perform a method for controlling trading volume in a trading system for trading stocks, the method comprising:
receiving a trade order outside of exchange trading hours from a non-institutional user indicating a number of shares to be traded in real-time;
determining a limit for a number of shares to be traded; and
rejecting the trade order based on whether the number of shares to be traded is equal to or greater than the determined limit.

7. The computer-readable medium of claim 7, further including the step of:
accepting the trade order if the amount of shares is less than the determined limit.

8. The computer-readable medium of claim 7, wherein the receiving step includes the step of:
receiving the trade order outside of exchange trading hours from a non-institutional user via a broker-dealer.

9. A computer-readable medium containing instructions for controlling a data processing system to perform a method for controlling trading volume in a trading system for trading stocks, the method comprising:
receiving a trade order outside of exchange trading hours from a non-institutional user indicating a number of shares to be traded in real-time;
determining a limit for a number of shares to be traded; and
flagging the trade order based on whether the number of shares to be traded is equal to or greater than the determined limit.

10. A computer-readable medium containing instructions for controlling a data processing system to perform a method for controlling trading volume in a trading system for trading stocks, the method comprising:
receiving a trade order indicating a number of shares to be traded;
determining a limit for a number of shares to be traded; and
rejecting the trade order based on whether the number of shares to be traded is equal to or greater than the determined limit.

11. A trading volume limitation system for a real-time computerized stock trading system, comprising:
a receiving component configured to receive a trade order outside of exchange trading hours from a non-institutional user;
a matching engine configured to match trade orders and execute trades in real-time between matching trade orders; and
a volume limiting component configured to receive a trade order indicating a number of shares to be traded, determine a limit for a number of shares to be traded, and reject the trade order based on whether the number of shares to be traded is equal to or greater than the determined limit.

12. A trading volume limitation system for a computerized stock trading system, comprising:
a receiving component configured to receive a trade order from a user;
a matching engine configured to match trade orders and execute trades between matching trade orders; and
an volume limiting component configured to receive a trade order indicating a number of shares to be traded, determine a limit for a number of shares to be traded, and reject the trade order based on whether the number of shares to be traded is equal to or greater than the determined limit.

13. A trading volume controlling system for a real-time computerized stock trading system, comprising:
means for receiving a trade order indicating a number of shares to be traded;
means for determining a limit for a number of shares to be traded; and
means for rejecting the trade order based on whether the number of shares to be traded is equal to or greater than the determined limit.
